(19) United States
(12) Patent Application Publication
(10) Pub. No.: US 2010/0310323 A1
(43) Pub. Date: Dec. 9, 2010

(54) ROCK BOLT ASSEMBLY

(75) Inventors: Anthony Dodds, Lambton (AU); Brett Goodman, Cameron Park (AU)

Correspondence Address: THE WEBB LAW FIRM, P.C., 700 KOPPERS BUILDING, 436 SEVENTH AVENUE, PITTSBURGH, PA, 15219, US

(73) Assignee: FCI HOLDINGS DELAWARE, INC., Pittsburgh, PA (US)

(21) Appl. No.: 12/865,288

(22) PCT Filed: Jan. 30, 2009
(86) PCT No.: PCT/AU09/00114

§ 371 Date: Aug. 23, 2010

(30) Foreign Application Priority Data
Jan. 31, 2008 (AU) 2008900424

(51) Int. Cl. E21D 20/00; E21D 21/00; F16B 13/06

(52) U.S. Cl. 405/259.5; 405/259.1; 411/44

(57) ABSTRACT

A rock bolt assembly comprising a rock bolt having an elongate shaft extending between opposite distal and proximal ends of the rock bolt, and a sheath disposed on the shaft at or adjacent the distal end of the bolt, the sheath having a body that extends about the shaft, the body having a longitudinal axis, opposite leading end and trailing end spaced apart along the axis, the body incorporating a cavity in which the shaft is disposed, the cavity extending from the trailing end of the body.

### TECHNICAL FIELD

The present invention relates to rock bolts suitable for use in the mining and tunneling industry to provide rock and wall support. The invention is suitable for hard rock applications as well in softer strata, such as that often found in coal mines, and it is to be appreciated that the term “rock” as used in the specification is to be given a broad meaning to cover both of these applications. The invention relates to a rock bolt assembly for use in installation of rock bolts.

### BACKGROUND

Roof and wall support is vital in mining and tunneling operations. Mine and tunnel walls and roofs consist of rock strata, which must be reinforced to prevent the possibility of collapse. Rock bolts are widely used for consolidating the rock strata.

In conventional strata support systems, a bore is drilled into the rock by a drill rod, which is then removed and a rock bolt is then installed in the drilled hole and secured in place typically using a resin or cement based grout. The rock bolt is tensioned which allows consolidation of the strata by placing that strata in compression. The rock bolt is typically formed from a steel rod.

To allow the rock bolt to be tensioned, the end of the bolt may be anchored mechanically to the rock formation by engagement of an expansion assembly on the end of bolt with the rock formation. Alternatively, the bolt may be adhesively bonded to the rock formation with a bonding material inserted into the bore hole. Alternatively, a combination of mechanical anchoring and bonding can be employed by using both an expansion assembly and resin bonding material.

A mechanically anchored rock bolt typically includes an expansion assembly threaded onto one end of the bolt shaft and a drive head for rotating the bolt. A plate is positioned between the drive head and the rock surface. The expansion assembly generally includes a multi-prong shell supported by a threaded ring and a plug threaded onto the end of the bolt. When the prongs of the shell engage with rock surrounding a bore hole, and the bolt is rotated about its longitudinal axis, the plug threads downwardly on the shaft to expand the shell into tight engagement with the rock thereby placing the bolt in tension between the expansion assembly and the mine rock surface.

When bonding material is used, the material penetrates the surrounding rock formation to adhesively unite the rock strata and to hold firmly the rock bolt within the bore hole. In one form of anchoring, resin is inserted into the bore hole in the form of a two component plastic cartridge having one component containing a curable resin composition and another component containing a curing agent (catalyst). The two component resin cartridge is inserted into the blind end of the bore hole and the rock bolt is inserted into the bore hole such that the end of the rock bolt ruptures the two component resin cartridge. Upon rotation of the mine rock bolt about its longitudinal axis, the compartments within the resin cartridge are shredded and the components are mixed. The resin mixture fills the annular area between the bore hole wall and the shaft of the mine rock bolt. The mixed resin cures and binds the rock bolt to the surrounding rock.

The resin cartridge is ordinarily made from thin plastic type film which encases and separates the mastic and catalyst. A significant concern with resin anchored rock bolts is that the plastic film is not sufficiently shredded and/or pushed back to the rear of the bore during mixing. As a result the plastic film can sit between the rock bolt and the bore hole wall and prevent the bonding of the rock bolt to the rock of the bore hole. Another concern is creating the required turbulence and torque for mixing the resin to evening combine the catalyst through the mastic. Under-mixing of the resin results in an unset resin which is low in strength.

### SUMMARY OF THE INVENTION

Disclosed is a rock bolt assembly comprising a rock bolt having an elongate shaft extending between opposite distal and proximal ends of the rock bolt, and a sheath disposed on the shaft at or adjacent the distal end of the bolt, the sheath having a body that extends about the shaft, the body having a longitudinal axis and opposite leading end and trailing end spaced apart along the axis, the body incorporating a cavity extending from the trailing end in which the shaft is disposed.

In one form the leading end of the sheath body extends over the distal end of the shaft. In one form the leading end is profiled to locate a resin capsule centrally on that end of the sheath.

The rock bolt assembly allows for a reduction in the annular region about the rock bolt assembly once the rock bolt assembly is inserted into a bore as compared with the annular region within a bore about a rock bolt without a sheath. A large annular region about the rock bolt within the bore increases the greater likelihood of the thin plastic film of the resin cartridge being deposited between the rock bolt and the bore wall and may not allow for the necessary turbulence within the space for mixing of the resin which can result in low-strength or un-set resin.

In one form the sheath further comprises one or more ridges that project outwardly from an outer surface of the body. In one form the ridges extend parallel with or at an angle to the longitudinal axis of the shaft. In one form the ridges are in the form of a helical thread. In one form one or more channels are positioned between the one or more ridges.

In one form the sheath is adapted to be secured to the rock bolt. In one form the sheath is secured to the rock bolt by means of a helical thread internal to the cavity. In this form the rock bolt includes a helical thread at its distal end. In one form the sheath is secured to the rock bolt by means of welding. In one form the sheath is secured to the rock bolt by means of adhesive. In one form the sheath is secured to the rock bolt by means of a press fit. In one form the sheath is secured to the rock bolt by means of a pin extending through the sheath and into at least a portion of the rock bolt. In one form the sheath is secured to the rock bolt by means of a resistance fit.

In a second aspect, disclosed is a sheath for a rock bolt having a shaft, the sheath comprising a body that extends along a longitudinal axis between opposite leading and trailing ends, and a cavity disposed in the body, the cavity extending along the longitudinal axis from the trailing end and being arranged to receive a portion of the shaft therein.

In one form the leading end of the body is closed. In one form the leading end of the body is profiled to locate a resin capsule centrally on the leading end. In one form the leading end is concave. In one form the leading end includes a depression.

In one form the sheath includes one or more ridges extending outwardly from the sheath. In one form the ridges are oriented such that they are substantially parallel to the longitudinal axis of the sheath.

In one form the sheath is adapted to be secured to the rock bolt. In one form the sheath is adapted to be secured to the rock bolt by means of a helical thread internal to the cavity. In one form the sheath is adapted to be secured to the rock bolt by means of welding. In one form the sheath is adapted to be secured to the rock bolt by means of adhesive. In one form the sheath is adapted to be secured to the rock bolt by means of a press fit. In one form the sheath is secured to the rock bolt by means of a pin. In one form the sheath is adapted to be secured to the rock bolt by means of a resistance fit.

In one form the ridges are oriented such that they are at an angle of less than 45 degrees to the longitudinal axis of the sheath.

In one form the ridges extend helically about the sheath.

In one form, channels extending along at least a portion of the length of the sheath are positioned between the ridges.

In a third aspect, disclosed is a method of installing a rock bolt in a bore comprising the steps of locating a sheath between a rock bolt and a resin capsule in the bore; and using the sheath to facilitate chemical fixing of the rock bolt by the resin within the bore.

In one form the sheath facilitates chemical fixing of the rock bolt by the resin within the bore by locating the resin capsule in alignment with the rock bolt.

In one form the sheath is caused to rotate and facilitates chemical fixing of the rock bolt by the resin within the bore by assisting in shredding of the capsule to release the resin on rotation of the sheath.

In one form the sheath is caused to rotate and facilitates chemical fixing of the rock bolt by the resin within the bore by promoting mixing of the resin components on rotation of the sheath.

In one form the sheath is fixed to the rock bolt and is arranged to rotate upon rotation of the rock bolt. In one form the sheath is fixed to the rock bolt by means of a cavity in the sheath into which a portion of the rock bolt is received. In one form the sheath is fixed to the rock bolt by means of a helical thread within the cavity in the sheath and a complementary helical thread on at least a portion of the rock bolt.

### BRIEF DESCRIPTION OF THE DRAWINGS

Preferred embodiments of the invention will now be described, by way of example only, with reference to the accompanying drawings in which:

FIG. 1 illustrates a cross-sectional view of one embodiment of a rock bolt assembly;

FIG. 2 illustrates a cross-sectional view of the rock bolt assembly of FIG. 1 in use on a rock bolt;

FIG. 3 illustrates a side view of the rock bolt assembly of FIG. 1;

FIG. 4 illustrates a top view of the rock bolt assembly of FIG. 1;

FIG. 5 illustrates a bottom view of the rock bolt assembly of FIG. 1;

FIG. 6 illustrates a cross sectional view of one embodiment of a rock bolt assembly being positioned in a bore;

FIG. 7 illustrates a side view of the rock bolt assembly of FIG. 6 after positioning in the bore;

FIG. 8 illustrates a top view of the rock bolt assembly of FIG. 6 in position in the bore.

### DETAILED DESCRIPTION OF PREFERRED EMBODIMENTS

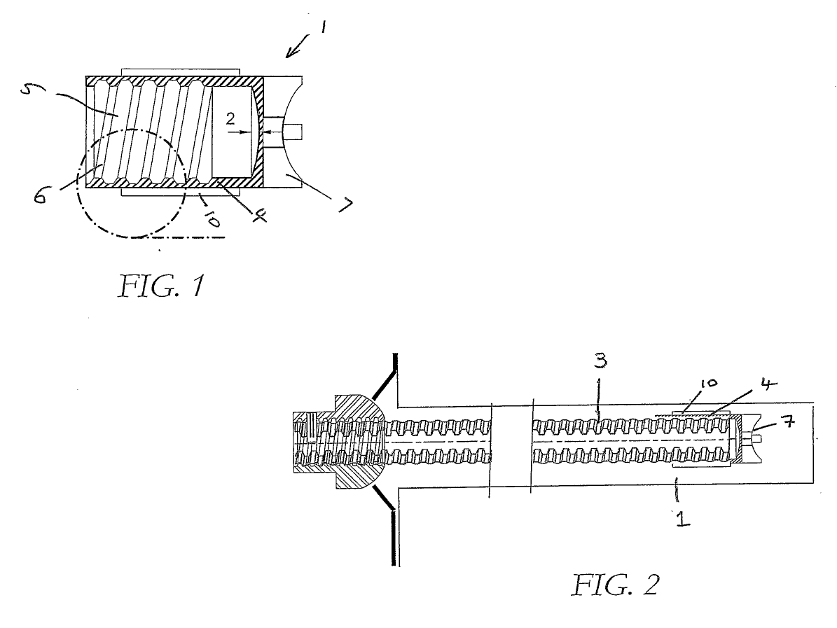

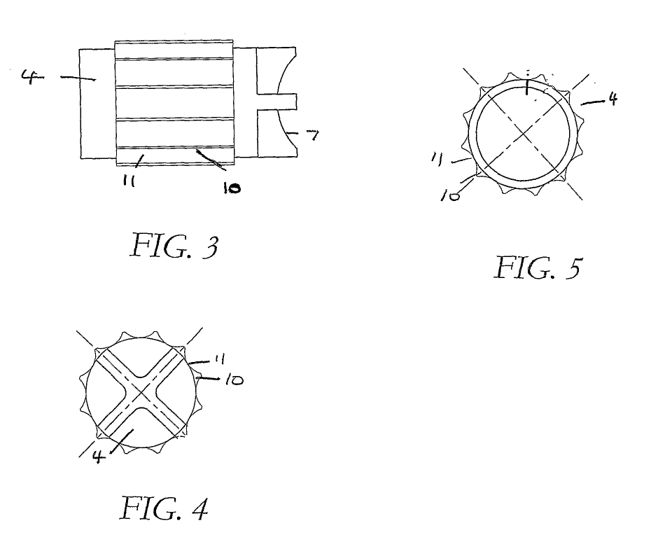

Referring to FIGS. 1 to 5, a preferred embodiment is a rock bolt assembly 1 for use with a rock bolt 3. The rock bolt assembly 1 comprises a sheath 4 adapted to be fitted over the leading end of rock bolt 3 for insertion into a bore in a rock surface which is being rock bolted.

The sheath 4 includes an internal cavity 5 adapted to fit the leading edge of the rock bolt 3. The internal cavity 5 includes a helical thread 6. Helical thread 6 is a female internal thread which is adapted to allow the sheath 4 of rock bolt assembly 1 to be connected with the leading edge of rock bolt 3. The helical thread 6 is a coarse thread from 6 mm to 10 mm pitch. In an alternative embodiment the thread comprises a rolled metric thread or a rope thread. In another not illustrated embodiment the sheath 4 is secured to the rock bolt 3 by means of a push fit, resistance fit or a pin lock. In yet another not illustrated embodiment the sheath 4 is welded to the rock bolt 3 or adhered thereto by means of adhesive.

The sheath 4 is preferably manufactured from metal which is molded, cast or machined into the preferred shape. The metal can be welded to the rock bolt. However, the sheath 4 may be made from other suitable materials, such as plastics, depending upon the application. The sheath may be made from multiple different materials.

The rock bolt 3 comprises a rigid elongate shaft 13 preferably manufactured from steel. However, the rock bolt 3 may be made from other suitable materials depending upon the application.

The leading end 7 of the sheath 4 is shaped to allow a resin capsule 20 to be positioned at the leading end 7 of the sheath 4. In the embodiment shown in the Figures the leading end 7 is concave however it will be seen that multiple shapes including a flat end, a depressed end, and an end with a connection means would allow for the resin capsule 20 to be so positioned.

The sheath 4 further includes multiple ridges 10 extending outwardly from the sheath 4. In the embodiment shown in the Figures the ridges run parallel to the axis of the rock bolt 3 and the sheath 4. In an alternative embodiment the ridges are positioned at an angle to the axis of the rock bolt 3. In yet another embodiment the ridges are positioned helically about the sheath 4. The helix is adapted to turn with or against the direction of rotation of the rock bolt and sheath 4 in use depending upon the application. In all embodiments the ridges 10 are adapted to rotate within the bore with the sheath 4 and the rock bolt 3.

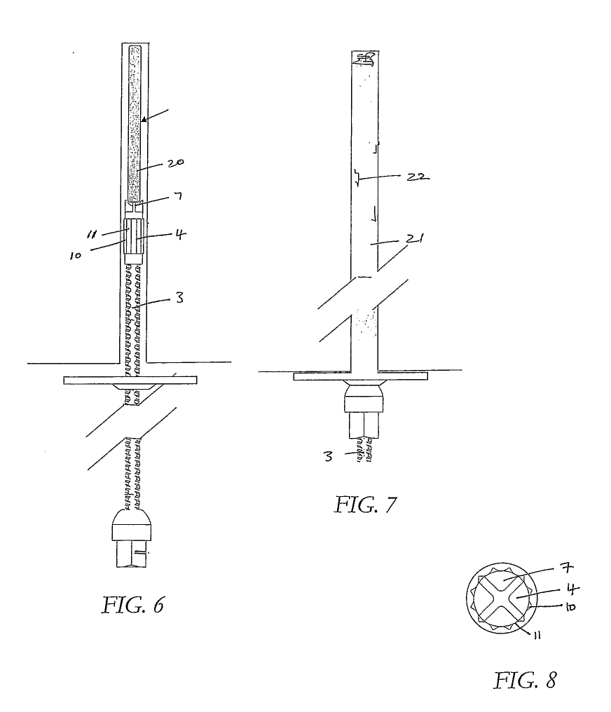

In use, as best shown in FIGS. 6 and 7, the sheath 4 is attached with the leading end of the rock bolt 3 by means of internal helical thread 5. A resin capsule 20 is positioned at the leading end 7 of the sheath 4. The resin capsule 20 may be positioned by placing the resin capsule 20 in the bore in the rock surface which is being rock bolted prior to insertion of the rock bolt 3 and sheath 4 into the bore. In that case when the sheath 4 and rock bolt 3 are inserted into the bore the resin capsule 20 moves into position at the leading end 7 owing to the concave surface of leading end 7. In an alternative method the resin capsule 20 is inserted into the bore simultaneously to the insertion of the rock bolt 3 and sheath 4 by positioning the resin capsule 20 at the leading edge 7 of the sheath 4 prior to insertion of the assembly into the bore.

The sheath 4 is sized such that upon insertion of the sheath 4 into the bore the annular distance between the sheath 4 and the edges of the bore is less than 3 mm. As an example of rock bolting practice, the resin capsule is commonly approximately 23 mm in diameter and the rock bolt is commonly approximately 24 mm in diameter. The bore, however, is commonly approximately 35 mm in diameter. This allows for a 5 mm annular gap between the rock bolt 3 and the bore at any point. The sheath 4, however, has a greater diameter than the rock bolt 3, allowing for a smaller gap between the rock bolt 3 and the bore surface.

The resin capsule 20, sheath 4 and rock bolt 3 are pushed into the bore. When the resin capsule 20 contacts the distal end of the bore the rock bolt 3 and sheath 4 are forced to continue further into the bore. The sheath 4 presses on the resin capsule 20, bursting and activating the resin capsule 20 by releasing the catalyst and mastic of the resin and allowing the catalyst and mastic to combine to form the resin.

When the sheath 4 and rock bolt 3 are rotated within the bore the multiple ridges 10 rotate within the bore and act as a blades shredding the capsule casing and ensuring the casing is pushed towards the rear of the bore. Channels 11 positioned between the ridges 10 allow for movement of the resin 21 which has been released from the resin capsule 20 along the sheath 4 and up the shaft of the rock bolt 3. Moreover, the ridges 10 and channels 11 interact to mix the resin 21. This ensures the catalyst and mastic of the resin are effectively mixed within the bore.

As shown best in FIG. 7, the insertion of the rock bolt 3 and sheath 4 results in shredded capsule casing film 22 being widely dispersed about the rock bolt 3 and sheath 4. The resin 21 surrounds the rock bolt 3 and sheath 4 and bonds with the bore surface. The resin 21 is therefore effective in bonding the rock bolt 3 to the bore.

It can be seen that the present embodiment improves the mixing of the resin mastic and catalyst within the bore and reduces the problem of a rock bolt 3 being “gloved” or surrounded by the casing of the resin capsule 20. This results in an effective bond between the bore surface and the rock bolt 3.

As will be understood, variations of the above described rock bolt system and sheath 4 can be made without departing from the scope of the appended claims. For example, in an alternative embodiment of the sheath 4 the sheath 4 may be square, triangular or hexagonal.

While the invention has been described in reference to its preferred embodiments, it is to be understood that the words which have been used are words of description rather than limitation and that changes may be made to the invention without departing from its scope as defined by the appended claims.

It is to be understood that a reference herein to a prior art document does not constitute an admission that the document forms part of the common general knowledge in the art in Australia or in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-38. (canceled)

39. A rock bolt assembly comprising:
a rock bolt having an elongate shaft extending between opposite distal and proximal ends of the rock bolt, and
a sheath disposed on the shaft at or adjacent the distal end of the bolt, the sheath having a body that extends about the shaft, the body having a longitudinal axis, opposite leading end and trailing end spaced apart along the axis, the body incorporating a cavity in which the shaft is disposed, the cavity extending from the trailing end of the body, wherein the body and shaft are fixed in relation to one another such that rotation of the shaft about the longitudinal axis rotates the body.

40. A rock bolt assembly according to claim 39, wherein the leading end of the sheath body is closed.

41. A rock bolt assembly according to claim 39, wherein the leading end of the sheath is profiled to locate a resin capsule centrally on the leading end of the sheath.

42. A rock bolt assembly according to claim 41, wherein the leading end of the sheath includes a depression.

43. A rock bolt assembly according to claim 39, wherein the sheath comprises one or more ridges that project outwardly from an outer surface of the body.

44. A rock bolt assembly according to claim 43, wherein channels extending along at least a portion of the length of the sheath are positioned between the ridges.

45. A rock bolt assembly according to claim 39, wherein the sheath is secured to the rock bolt by means of a threaded coupling that includes an external helical thread disposed on the shaft and a complementary internal helical thread disposed on an internal surface of the sheath that defines the cavity.

46. A sheath for a rock bolt having a shaft, the sheath comprising a body that extends along a longitudinal axis between opposite leading end and trailing end, and a cavity disposed in the body, the cavity extending along the longitudinal axis from the trailing end and being arranged to receive a portion of the shaft therein such that rotation of the shaft about the longitudinal axis effects rotation of the sheath, the body having an external profile that includes channels extending longitudinally along the body.

47. A sheath according to claim 46, wherein the leading end of the body is closed.

48. A sheath according to claim 46, wherein the leading end of the body is profiled to locate a resin capsule centrally on the leading end.

49. A sheath according to claim 47, wherein the leading end includes a depression.

50. A sheath according to claims 46, further comprising one or more ridges that project outwardly from an outer surface of the body.

51. A sheath according to claim 49, wherein the ridges are substantially parallel to the longitudinal axis of the body.

52. A sheath according to claim 49, wherein the channels are positioned between the ridges.

53. A sheath according to claim 46, wherein the cavity includes a helical thread.

54. A method of installing a rock bolt in a bore comprising the steps of:
locating a sheath between a shaft of a rock bolt, and a resin capsule in the bore, the sheath being fitted to the shaft so that rotation of the shaft effects rotation of the sheath, and
using the sheath to facilitate chemical fixing of the rock bolt by the resin within the bore.

55. A method of installing a rock bolt in a bore according to claim 54, wherein the sheath facilitates chemical fixing of the rock bolt by the resin within the bore by locating the resin capsule in alignment with the rock bolt shaft.

56. A method of installing a rock bolt in a bore according to claim 54, wherein the sheath facilitates chemical fixing of the rock bolt by the resin within the bore by assisting in shredding of the capsule to release the resin on rotation of the sheath.

57. A method of installing a rock bolt in a bore according to claim 54, wherein the sheath is caused to rotate and facilitates chemical fixing of the rock bolt by the resin within the bore by promoting mixing of the resin components on rotation of the sheath.

58. A sheath for a rock bolt having a shaft, the sheath comprising a body that extends along a longitudinal axis between opposite leading end and trailing end, and a cavity disposed in the body, the cavity extending along the longitudinal axis from the leading end to the trailing end, and a cavity disposed in the body, the cavity extending along the longitudinal axis from the trailing end and being arranged to receive a portion of the shaft therein such that rotation of the shaft about the longitudinal axis effects rotation of the sheath, the body having a closed leading end.

59. A sheath for a rock bolt having a shaft according to claim 58, wherein the leading end of the body is profiled to locate a resin capsule centrally on the leading end.

60. A sheath for a rock bolt having a shaft according to claim 58, wherein the leading end of the body includes a concave depression.
